(19) United States
(12) Patent Application Publication
(10) Pub. No.: US 2026/0164387 A1
(43) Pub. Date: Jun. 11, 2026

(54) METHOD AND APPARATUS FOR HANDLING UNAVAILABILITY PERIOD COLLISION IN WIRELESS NETWORK

(71) Applicant: SAMSUNG ELECTRONICS CO., LTD., Suwon-si, Gyeonggi-do (KR)

(72) Inventors: Lalith KUMAR, Bangalore (IN); Danish Ehsan HASHMI, Bangalore (IN); Krishnamurthy D R, Bangalore (IN); Jagadeesh GANDIKOTA, Bangalore (IN); Koustav ROY, Bangalore (IN)

(21) Appl. No.: 19/127,291

(22) PCT Filed: Nov. 2, 2023
(86) PCT No.: PCT/KR2023/017383

§ 371 Date: May 5, 2025

(30) Foreign Application Priority Data
Nov. 4, 2022 (IN) 202241063011
Sep. 29, 2023 (IN) 202241063011

(51) Int. Cl. H04W 60/00; H04W 12/06

(52) U.S. Cl. CPC H04W 60/002; H04W 12/06

(57) ABSTRACT

The disclosure relates to a 5G or 6G communication system for supporting a higher data transmission rate. Specifically, the disclosure related to a method for handling unavailability period collision in a wireless network (1000) by a network apparatus (200). The method includes identifying that a collision occurs between a network slice specific authentication and authorization (NSSAA) procedure and a registration procedure. Further, the method includes in case that a registration request message for the registration procedure includes information on an unavailable period, aborting the NSSAA procedure.

### TECHNICAL FIELD

The present disclosure relates generally to wireless communication systems and, more specifically, the present disclosure relates to method and apparatus for unavailability period collision case handling in a wireless network. This application is based on and derives the benefit of Indian Provisional Application 202241063011 filed on 4 Nov. 2022, and Indian Complete Application 202241063011 filed on 29 Sep. 2023, the contents of which are incorporated herein by reference.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to provide a method and a wireless network for unavailability period collision case handling in the wireless network.

Another object of the embodiments herein is to determine whether a registration request message including an unavailability period duration IE when the registration request message is received before completing ongoing NSSAA procedure.

Another object of the embodiments herein is to abort a Network slice-specific authentication and authorization (NSSAA) procedure and progress with a mobility and periodic registration update procedure when the registration request message includes the unavailability period duration IE.

Another object of the embodiments herein is to progress with the mobility and periodic registration update procedure and the NSSAA procedure when the registration request message does not include the unavailability period duration IE.

### Solution to Problem

The embodiments herein provide a method for handling unavailability period collision in a wireless network. The method includes receiving, by a network apparatus, a registration request message for mobility and periodic registration update procedure from a UE. Further, the method includes sending, by the network apparatus, a NSSAA message corresponding to a NSSAA procedure from an AMF device. Further, the method includes determining, by the network apparatus, that the registration request message is received before completing an ongoing NSSAA procedure. Further, the method includes determining, by the network apparatus, whether the registration request message includes an unavailability period duration IE when the registration request message is received before completing the ongoing NSSAA procedure. In an embodiment, the method includes aborting the NSSAA procedure and progressing with the mobility and periodic registration update procedure when the registration request message includes the unavailability period duration IE. In another embodiment, the method includes progressing with the mobility and periodic registration update procedure and the NSSAA procedure when the registration request message does not include the unavailability period duration IE.

In an embodiment, the NSSAA message is a NSSAA command.

Accordingly, the embodiments herein provide a method for handling unavailability period collision in a wireless network. The method includes sending, by a UE, a registration request message for mobility and periodic registration update procedure to a network apparatus. Further, the method includes receiving, by the UE, a NSSAA message corresponding to a NSSAA procedure from an AMF device. Further, the method includes determining, by the UE, that the NSSAA command message is received before completing an ongoing mobility and periodic registration update procedure. Further, the method includes determining, by the UE, whether the registration request message includes an unavailability period duration IE when the NSSAA command message is received before completing the ongoing mobility and periodic registration update procedure. In an embodiment, the method includes ignoring the NSSAA message and progressing with the mobility and periodic registration update procedure, when the registration request message includes the unavailability period duration IE. In another embodiment, the method includes progressing with the mobility and periodic registration update procedure and the NSSAA procedure when the registration request message does not include the unavailability period duration IE.

Accordingly, the embodiments herein provide a network apparatus for handling unavailability period collision in a wireless network. The network apparatus includes an unavailability period collision controller communicatively coupled to a memory and a processor. The unavailability period collision controller is configured to receive a registration request message for mobility and periodic registration update procedure from a UE. Further, the unavailability period collision controller is configured to send a NSSAA message corresponding to a NSSAA procedure from an AMF device. Further, the unavailability period collision controller is configured to determine that the registration request message is received before completing ongoing NSSAA procedure. Further, the unavailability period collision controller is configured to determine whether the registration request message includes an unavailability period duration IE when the registration request message is received before completing the ongoing NSSAA procedure. In an embodiment, the unavailability period collision controller is configured to abort the NSSAA procedure and progressing with the mobility and periodic registration update procedure when the registration request message includes the unavailability period duration IE. In another embodiment, the unavailability period collision controller is configured to progress with the mobility and periodic registration update procedure and the NSSAA procedure when the registration request message does not include the unavailability period duration IE.

Accordingly, the embodiments herein provide a UE for handling unavailability period collision in a wireless network. The UE includes an unavailability period collision controller communicatively coupled to a memory and a processor. The unavailability period collision controller is configured to send a registration request message for mobility and periodic registration update procedure to a network apparatus. Further, the unavailability period collision controller is configured to receive a NSSAA message corresponding to a NSSAA procedure from an AMF device. Further, the unavailability period collision controller is configured to determine that the NSSAA command message is received before completing an ongoing mobility and periodic registration update procedure. Further, the unavailability period collision controller is configured to determine whether the registration request message includes an unavailability period duration IE when the NSSAA command message is received before completing the ongoing mobility and periodic registration update procedure. In an embodiment, the unavailability period collision controller is configured to ignore the NSSAA message and progressing with the mobility and periodic registration update procedure when the registration request message includes the unavailability period duration IE. In an embodiment, the unavailability period collision controller is configured to progress with the mobility and periodic registration update procedure and the NSSAA procedure when the registration request message does not include the unavailability period duration IE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### BRIEF DESCRIPTION OF DRAWINGS

The UE and the network apparatus are illustrated in the accompanying drawings, throughout which like reference letters indicate corresponding parts in the various figures. The embodiments herein will be better understood from the following description with reference to the drawings, in which:

FIG. 1 is a sequential diagram illustrating signalling among a UE, a network apparatus (e.g., g-NodeB) and an AMF device in a wireless network, according to a prior art;

FIG. 2 is a sequential diagram illustrating signalling among a UE, a network apparatus (e.g., g-NodeB) and an AMF device in a wireless network, according to a prior art;

FIG. 3 is a sequential diagram illustrating signalling among the UE, the network apparatus (e.g., g-NodeB) and the AMF device for unavailability period collision case handling in the wireless network, according to an embodiment as disclosed herein;

FIG. 4 illustrates various hardware components of the UE, according to the embodiments as disclosed herein;

FIG. 5 illustrates various hardware components of the network apparatus, according to the embodiments as disclosed herein;

FIG. 6 is a flow chart illustrating a method, implemented by the UE, for handling the unavailability period collision in the wireless network, according to the embodiments as disclosed herein;

FIG. 7 is a flow chart illustrating a method, implemented by the network apparatus, for handling the unavailability period collision in the wireless network, according to the embodiments as disclosed herein;

FIG. 8 is another sequential diagram illustrating signalling among the UE, the network apparatus (e.g., g-NodeB) and the AMF device for unavailability period collision case handling in the wireless network, according to an embodiment as disclosed herein; and

FIG. 9 is another sequential diagram illustrating signalling among the UE, the network apparatus (e.g., g-NodeB) and the AMF device for unavailability period collision case handling in the wireless network, according to an embodiment as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Embodiments herein disclose a method for handling unavailability period collision in a wireless network. The method includes receiving, by a network apparatus, a registration request message for mobility and periodic registration update procedure from a UE. Further, the method includes sending, by the network apparatus, a Network slice-specific authentication and authorization (NSSAA) message corresponding to a NSSAA procedure from an AMF device. Further, the method includes determining, by the network apparatus, that the registration request message is received before completing ongoing NSSAA procedure. Further, the method includes determining, by the network apparatus, whether the registration request message includes an unavailability period duration IE when the registration request message is received before the completing ongoing NSSAA procedure. In an embodiment, the method includes aborting the NSSAA procedure and progressing with the mobility and periodic registration update procedure when the registration request message includes the unavailability period duration IE. In another embodiment, the method includes progressing with the mobility and periodic registration update procedure and the NSSAA procedure when the registration request message does not include the unavailability period duration IE.

Based on the proposed method, upon detecting a collision between a network initiated procedure and a registration request message from the UE, the wireless network and the UE aborts the network-initiated NAS transport procedure or identify request procedure or generic UE configuration update procedure or NSSAA procedure, and progresses the registration request procedure. Thus, results in reducing the wait time for the start of unavailability event at the UE because UE and network need not execute the procedure initiated by the network which lead to collision case, in the process saving the resource wastage and processing power at the UE and the AMF device, helping to execute the unavailability period event as early as possible.

In an embodiment, during the collision case between the registration procedure and the NSSAA procedure, when the unavailability period is included in a registration request message, the UE and the network apparatus will progress with registration procedure, and the UE and the network apparatus will abort/ignore the NSSAA procedure.

In an embodiment, during the collision case between the registration procedure and the NSSAA procedure, when the unavailability period is not included in the registration request message, the UE and the network apparatus will progress with registration procedure and also the NSSAA procedure.

If the network apparatus receives a registration request message before the ongoing network slice-specific authentication and authorization procedure has been completed and the registration request message includes the unavailability period duration IE, the network apparatus shall abort the network slice-specific authentication and authorization procedure and shall progress the registration procedure for mobility and periodic registration update procedure.

If the network apparatus receives a registration request message before the ongoing network slice-specific authentication and authorization procedure has been completed and the registration request message does not include the unavailability period duration IE, both procedures shall be progressed.

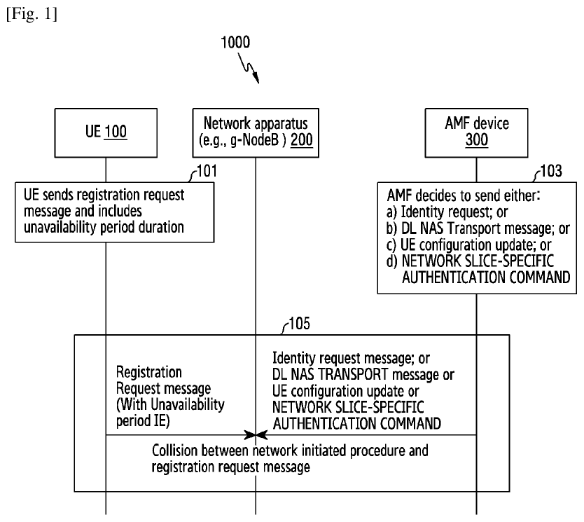

Referring now to the drawing, FIG. 1 through FIG. 9, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

FIG. 1 is a sequential diagram illustrating signalling between a UE (100), a network apparatus (e.g., g-NodeB) (200) and an Access & Mobility Management Function (AMF) device (300) in a wireless network (1000), according to prior art. At step 101, due to existing triggers, the UE (100) triggers a registration request message including unavailability period (duration) information element (IE). At the same time, at step 103 to 105, the AMF device (300) initiates at least one of an identity request, or downlink (DL) Non Access Stratum (NAS) transport message, or a UE configuration update, or a network slice-specific authentication command. The UE (100) receives the identify request message or the DL NAS transport message or the UE CONFIGURATION COMMAND message for processing. When the UE (100) and the network proceed with the identification procedure or the DL (downlink) NAS TRANSPORT message (also called as Network-initiated NAS transport procedure) or the UE configuration update procedure or the network slice-specific authentication and authorization procedure, then request to release the NAS signalling connection will be delayed and the NAS signalling connection can delay the operations planned at the UE (100) during an unavailability period.

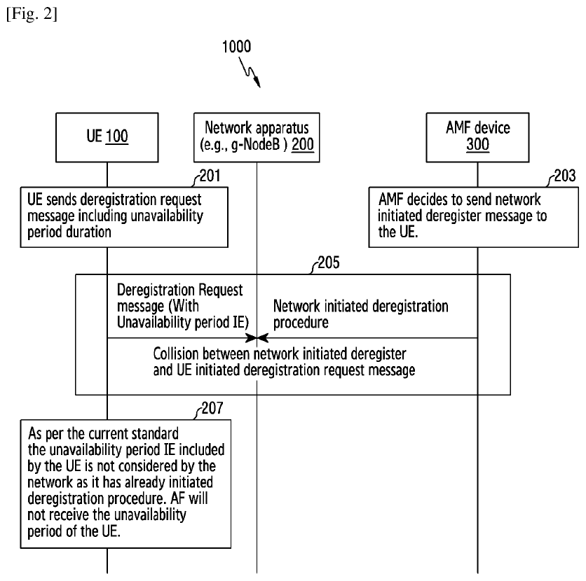

FIG. 2 is a sequential diagram illustrating signalling between the UE (100), the network apparatus (e.g., g-NodeB) (200) and the AMF device (300) in the wireless network (1000), according to prior art. Collision of the UE initiated deregistration procedure including unavailability period and network-initiated procedure. At step 201, the UE (100) sends a deregistration request message including unavailability period duration. Meanwhile, the AMF device (300) also decides to send the network initiated deregister message to the UE (100) at step 203. Thus, leading to a collision case between the UE initiated and network-initiated procedure at step 205. As per the current standard, the unavailability period IE included by the UE (100) is not considered by the network apparatus (200) as the UE (100) has already initiated deregistration procedure at 207. The AMF device (300) will not receive the unavailability period of the UE (100) and the synchronization between the UE (100) and the AMF device (300) will not be possible.

It is desired to address the above mentioned disadvantages or other short comings or at least provide a useful alternative.

FIG. 3 is a sequential diagram illustrating signalling between the UE (100), the network apparatus (200) and the AMF device (300) for unavailability period collision case handling in a wireless network (1000), according to an embodiment as disclosed herein. The wireless network (1000) can be, for example, but not limited to a fourth generation (4G) network, a fifth generation (5G) network, a sixth generation (6G) network, and an Open Radio Access Network (ORAN). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, and a new radio (NR) trans-receiver.

Collision of registration request and identification procedure/DL NAS TRANSPORT procedure/Generic UE configuration update procedure/Network slice-specific authentication and authorization procedure are explained below in the context of unavailability period collision case handling in the wireless network (1000). The steps are following:
1) The UE (100) sends registration request (RR) message with an unavailability period IE (also called as unavailability period duration or the unavailability period IE can be any name indicating a time (or timer) or time-slot or duration (with timer value) in which the UE (100) intends to become unavailable), the time-slot can indicate whether the unavailability period will start immediately or at later point of time, for e.g. it may include the start time which will indicate to the network that unavailability period will start at later point of time or time-slot will indicate a time like 3 p.m to 5 p.m while UE is indicating at 1 O clock or it may have the duration for e.g. UE indicates at 1 O clock and includes the duration of 100 seconds indicating unavailability period will start after 100 seconds etc or any other method. and now when the UE (100) receives the identify request message or DL NAS transport message or the configuration update command message or a network slice-specific authentication command message for processing then, the UE (100) identifies that there is a collision case at step 301 to 305.
2) At the network apparatus (200), after the AMF (300) has initiated a NAS procedure (identification procedure/DL NAS TRANSPORT procedure/Generic UE configuration update procedure/Network slice-specific authentication and authorization procedure or any other network initiated NAS procedure as listed in 3GPP TS 24.501) by sending a respective NAS message, receives registration request message or deregistration request message or any other NAS message (listed in 24.501) initiated by the UE (100), with unavailability period IE. The network apparatus (200) identifies that there is a collision between the network initiated NAS procedure and the UE (100) initiated registration request procedure at step 305.
3) At both the UE (100) and the network apparatus (200), the network-initiated NAS transport procedure or the identify request procedure or the configuration update command or the network slice-specific authentication and authorization procedure is aborted/i.e. respective message is ignored/discarded at step 307 and 309. The registration request procedure is progressed by both the UE (100) and the network apparatus (200).

In another embodiment, at both the UE (100) and the network, the network-initiated NAS transport procedure or the identify request procedure or the network slice-specific authentication and authorization procedure shall be progressed and the registration request procedure is also progressed. In yet another embodiment, the operations can be done irrespective of whether the UE (100) has included the Unavailability period IE in the RR message.

In another embodiment, at both the UE (100) and the network apparatus (200), the network-initiated NAS transport procedure or the identify request procedure or the network slice-specific authentication and the authorization procedure shall be progressed and the registration request procedure is aborted. In yet another embodiment, the operations can be done irrespective of whether the UE (100) has included the unavailability period IE in the RR message.

Case 1.1: (RR procedure progressed and ignore/Discard Network initiated procedure) identification procedure/DL NAS TRANSPORT procedure/Generic UE configuration update procedure/Network slice-specific authentication and authorization procedure and registration request procedure collision, at the UE side (100):
1) When the registration request message (or any other NAS message, e.g. deregistration request message) does not include the unavailability period duration IE and the UE (100) receives the identify request message or the DL NAS transport message or the configuration update command message or the network slice-specific authentication command message before the ongoing registration request procedure (or the deregistration procedure) has been completed, the UE (100) shall proceed with both the procedures.
2) When the registration request message (or any other NAS message, e.g. deregistration request message) includes the unavailability period duration IE and the UE (100) receives the identify request message or the DL NAS transport message or the configuration update command message or the network slice-specific authentication command message before the ongoing registration request procedure has been completed, the UE (100) shall ignore/discard the identify request message or the DL NAS transport message or the configuration update command message or network slice-specific authentication command message, i.e. abort respective procedure and proceed with the registration request procedure (or deregistration procedure).

At the network side:
1) When the network receives the registration request message (or any other NAS message e.g., deregistration request message) before the ongoing generic UE configuration update procedure/network-initiated NAS transport procedure/Identify request procedure/NSSAA procedure has been completed and the registration request message (or any other NAS message, e.g., deregistration request message) does not include the unavailability period duration IE, both the procedures shall be progressed.
2) When the network receives the registration request message (or any other NAS message e.g., deregistration request message) before the ongoing generic UE configuration update procedure/network-initiated NAS transport procedure/identify request procedure/NSSAA procedure has been completed and the registration request message (or any other NAS message, e.g., deregistration request message) includes the unavailability period duration IE, the network apparatus (200) shall abort the generic UE configuration update/network-initiated NAS transport procedure/Identify request procedure and shall progress the registration procedure (or the deregistration procedure).

Case 1.2: (RR procedure aborted and progress Network initiated procedure) Identification procedure/DL NAS TRANSPORT procedure/Generic UE configuration update procedure/Network slice-specific authentication and authorization procedure and registration request procedure collision, at the UE side (100):
1) When the registration request message(or any other NAS message, e.g. deregistration request message) does not include the unavailability period duration IE and the UE (100) receives the identify request message or the DL NAS transport message or the configuration update command message or the network slice-specific authentication command message before the ongoing registration request procedure (or deregistration procedure) has been completed, the UE (100) shall proceed with both the procedures.
2) When the registration request message (or any other NAS message) includes the unavailability period duration IE and the UE (100) receives the identify request message or the DL NAS transport message or the configuration update command message or the network slice-specific authentication command message before the ongoing registration request procedure has been completed, the UE (100) shall progress with the identify request message or the DL NAS transport message or the configuration update command message or the network slice-specific authentication command message and abort the registration procedure (or deregistration procedure).

At the network side:
1) When the network receives the registration request message (or any other NAS message e.g. deregistration request message) before the ongoing generic UE configuration update procedure/network-initiated NAS transport procedure/Identify request procedure/NSSAA has been completed and the registration request message(or any other NAS message, e.g. deregistration request message) does not include Unavailability period duration IE both the procedures shall be progressed.
2) When the network receives the registration request message before the ongoing generic UE configuration update procedure/network-initiated NAS transport procedure/Identify request procedure/NSSAA has been completed and the REGISTRATION REQUEST message (or any other NAS message) does include Unavailability period duration IE, the network shall progress with the generic UE configuration update/network-initiated NAS transport procedure/Identify request procedure and shall abort the registration/deregistration procedure.

Case 1.3: (RR procedure progressed and also progress Network initiated procedure) Identification procedure/DL NAS TRANSPORT procedure/Generic UE configuration update procedure/Network slice-specific authentication and authorization procedure and registration request procedure collision, at the UE side (100):
1) When the registration request message (or any other NAS message e.g. deregistration procedure) does not include Unavailability period duration IE and the UE (100) receives the identify request message or the DL NAS transport message or the configuration update command message or the network slice-specific authentication command message before the ongoing registration request procedure has been completed, the UE (100) shall proceed with both the procedures.
2) When the registration request message(or any other NAS message e.g. deregistration procedure) includes Unavailability period duration IE and the UE (100) receives the identify request message or the DL NAS transport message or the configuration update command message or the network slice-specific authentication command message before the ongoing registration request procedure has been completed, the UE (100) shall progress with the identify request message or the DL NAS transport message or the configuration update command message or the network slice-specific authentication command message and also progress the registration/deregistration procedure.

At the network side:
1) When the network receives a registration request message (or any other NAS message e.g. deregistration request message) before the ongoing generic UE configuration update procedure/network-initiated NAS transport procedure/Identify request procedure has been completed and the registration request message(or any other NAS message, e.g. deregistration request message) does not include Unavailability period duration IE both the procedures shall be progressed.
2) When the network receives the registration request message (or any other NAS message e.g. deregistration request message) before the ongoing generic UE configuration update procedure/network-initiated NAS transport procedure/Identify request/NSSAA procedure has been completed and the registration request message (or any other NAS message, e.g. deregistration) includes Unavailability period duration IE, the network shall progress with the generic UE configuration update/network-initiated NAS transport procedure/Identify request procedure and also progress the registration procedure.

In another embodiment, the DL NAS TRANSPORT message due to the network-initiated NAS transport procedure is received with acknowledgement (ACK) bit set (i.e. acknowledgement is requested) by the UE (100) then only registration request procedure or deregistration procedure indicating unavailability period is progressed and the network-initiated NAS transport procedure is aborted i.e. For example, when a Steering of Roaming (SOR) transparent container or UE parameters update transparent container are received with ACK bit set. In another embodiment, DL NAS TRANSPORT message due to the network-initiated NAS transport procedure is sent by the network (e.g., AMF device (300)) with ACK bit set(i.e. acknowledgement is requested) to the UE (100) and registration/deregistration request message indicating unavailability period is received by the network then only registration request procedure or deregistration request procedure is progressed and the network-initiated NAS transport procedure is aborted i.e. For example, when SOR transparent container or UE parameters update transparent container are sent with ACK bit set. In yet another embodiment, DL NAS transport message due to the network-initiated NAS transport procedure is received by the UE (100) without ACK bit set (i.e., acknowledgement is not requested) and the network receives registration/deregistration request (with unavailability period IE) then both the procedures are progressed i.e. For example, when SOR transparent container or the UE parameters update transparent container are received without setting the ACK bit.

Collision of the network initiated Generic UE configuration update procedure and UE initiated registration procedure:
1) When the UE (100) has sent registration request (including unavailability period IE) and if the UE (100) receives configuration update command message due to Generic UE configuration update procedure but does not require the UE (100) to send the response message (for example configuration update complete or trigger new procedure like registration procedure). Then the UE (100) and the network shall continue with both the procedures.
2) When the network apparatus (200) sent the configuration update command message due to the generic UE configuration update procedure and the network apparatus (200) receives the registration request (including unavailability period IE), but does not require UE (100) to send the response message, for example configuration update complete or trigger new procedure like registration procedure. Then the UE (100) and the network apparatus (200) shall continue with both the procedures.
3) When the UE (100) has sent registration/deregistration request (including unavailability period IE) and if the UE (100) receives the configuration update command message due to the generic UE configuration update procedure but the network apparatus (200) requires the UE (100) to send the response message (for example configuration update complete or trigger new procedure like registration procedure). Then, the UE (100) and the network apparatus (200) shall abort the generic UE configuration update procedure and progress with registration/deregistration procedure.
4) When the network apparatus (200) sent the configuration update command message due to Generic UE configuration update procedure and the network apparatus (200) receives registration/deregistration request (including unavailability period IE), but the network apparatus (200) requires the UE (100) to send the response message, for example configuration update complete or trigger new procedure like registration procedure. Then the UE (100) and the network shall abort the Generic UE configuration update procedure and progress with registration request procedure.

The configuration update command message with any indication for example “acknowledgement requested” or “registration requested” or when the UE (100) receives the Network slicing indication IE in the configuration update command message with the Network slicing subscription change indication set to “Network slicing subscription changed” then, the UE (100) to trigger response NAS message or trigger a new NAS procedure (like registration procedure).

In summary, when a NAS message is received with an information such that the network apparatus (200) requires UE (100) to send the response NAS message or trigger a new NAS procedure(refer to 24.501 for all such cases) then the network-initiated NAS procedure is aborted and registration/deregistration request procedure is progressed by both the UE (100) and the network (e.g., AMF device (300)) so that the network can release the NAS signalling connection immediately for the collision cases discussed in this embodiment.

The UE initiated and network initiated De-registration procedure collision:
1) When the network apparatus (200) receives the deregistration request message (sent by the UE) with “switch off” indication, before the network-initiated deregistration procedure has been completed, both procedures shall be progressed and considered completed. That is, the UE initiated deregistration request procedure is progressed, when unavailability period is included, the AMF device (300) shall consider the received unavailability period. In other words, if there is “Loss of Connectivity” event subscription for the UE (100) by the AMF device (300), the AMF device (300) considers Unavailability Period (optionally the remaining time) when constructing the “Loss of Connectivity” event or includes the unavailability period as received from the UE (100) and report towards the NEF and the Unavailability Period is reported to the respective subscribed AMF device (300).
2) When the network apparatus (200) receives the deregistration request message without “switch off” indication, before the network-initiated de-registration procedure has been completed, the network shall send a deregistration accept message to the UE (100) and also progress the UE initiated deregistration request procedure is progressed. When unavailability period is included, the AMF device (300) shall consider the received unavailability period (optionally the remaining time), i.e. If there is “Loss of Connectivity” event subscription for the UE (100) by AMF device (300), the AMF device (300) considers the Unavailability Period (optionally the remaining time) when constructing the “Loss of Connectivity” event or includes the unavailability period as received from the UE (100) and report towards the NEF and the Unavailability Period is reported to the respective subscribed AMF device (300).

In an embodiment, the UE initiated deregistration request/registration procedure is progressed implies that when unavailability period is included, the AMF device (300) shall consider the received unavailability period (optionally the remaining time), i.e. If there is “Loss of Connectivity” event subscription for the UE (100) by the AMF device (300), the AMF device (300) considers the Unavailability Period(optionally the remaining time) when constructing the “Loss of Connectivity” event or includes the unavailability period as received from the UE (100) and report towards the NEF and the unavailability period is reported to the respective subscribed AMF device (300). The AMF device (300) will also consider unavailability period to determine the periodic registration update timer for the UE (100) and will not page the UE (100) until the UE (100) comes back into the connected state. The AMF device (300) may take the Unavailability Period Duration into account when determining Periodic Registration Update timer value. The AMF device (300) may provide a Periodic Registration Update time longer than or equal to Unavailability Period Duration to avoid interfering with the UE (100) dealing with the event that causes the unavailability. The AMF device (300) stores the information that the UE (100) is unavailable in UE context, and considers the UE (100) is unreachable (i.e., clear the PPF in AMF device (300)) until the UE (100) enters CM-CONNECTED state. While the UE (100) is unreachable, all high latency communication solutions apply if supported in the network, e.g., extended data buffering, downlink data buffering status report, etc.

Identification procedure/DL NAS TRANSPORT procedure/Generic UE configuration update procedure/Network slice-specific authentication and authorization procedure and registration request procedure collision:

When the UE (100) has received configuration update command/identity request message/DL NAS TRANSPORT message/procedure/Network slice-specific authentication and authorization message when it had sent the registration request message with unavailability period IE before the completion of the registration procedure.

The network has received registration request message (including unavailability period IE) when the network apparatus (200) sent configuration update command/identity request message/DL NAS TRANSPORT message/procedure/Network slice-specific authentication and authorization message before the completion of respective procedure. Procedure is aborted in this embodiment implies(is) the received NAS message is ignored/discarded by the receiving entity for e.g., the UE (100) or the AMF device (300).

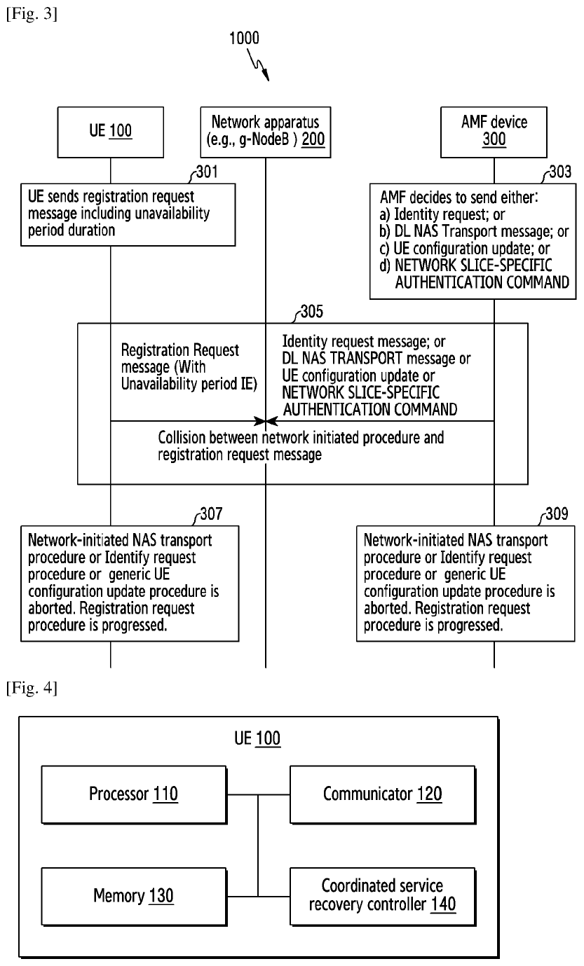

FIG. 4 illustrates various hardware components of the UE (100), according to the embodiments as disclosed herein. In an embodiment, the UE (100) includes a processor (110), a communicator (120), a memory (130) and a controller (140). The processor (110) is coupled with the communicator (120), the memory (130) and the unavailability period collision controller (140).

The unavailability period collision controller (140) sends the registration request message for mobility and periodic registration update procedure to the network apparatus (200). Further, the unavailability period collision controller (140) receives the NSSAA message (e.g., NSSAA command or the like) corresponding to the NSSAA procedure from the AMF device (300). Further, the unavailability period collision controller (140) determines that the NSSAA command message is received before completing the ongoing mobility and periodic registration update procedure. Further, the unavailability period collision controller (140) determines whether the registration request message includes the unavailability period duration IE when the NSSAA command message is received before completing the ongoing mobility and periodic registration update procedure. In an embodiment, the unavailability period collision controller (140) ignores the NSSAA message and progresses with the mobility and periodic registration update procedure, when the registration request message includes the unavailability period duration IE. In an embodiment, the unavailability period collision controller (140) progresses with the mobility and periodic registration update procedure and the NSSAA procedure when the registration request message does not include the unavailability period duration IE.

The unavailability period collision controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 4 illustrates various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 5 illustrates various hardware components of the network apparatus (200), according to the embodiments as disclosed herein. In an embodiment, the network apparatus (200) includes a processor (210), a communicator (220), a memory (230) and an unavailability period collision controller (240). The processor (210) is coupled with the communicator (220), the memory (230) and the unavailability period collision controller (240).

The unavailability period collision controller (240) receives the registration request message for the mobility and periodic registration update procedure from the UE (100). Further, the unavailability period collision controller (240) sends the NSSAA message corresponding to the NSSAA procedure from the AMF device (300). Further, the unavailability period collision controller (240) determines that the registration request message is received before completing the going NSSAA procedure. Further, the unavailability period collision controller (240) determines whether the registration request message includes the unavailability period duration IE when the registration request message is received before completing the going NSSAA procedure. In an embodiment, the unavailability period collision controller (240) aborts the NSSAA procedure and progresses with the mobility and periodic registration update procedure, when the registration request message includes the unavailability period duration IE. In another embodiment, the unavailability period collision controller (240) progresses with the mobility and periodic registration update procedure and the NSSAA procedure, when the registration request message does not include the unavailability period duration IE.

The unavailability period collision controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 5 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

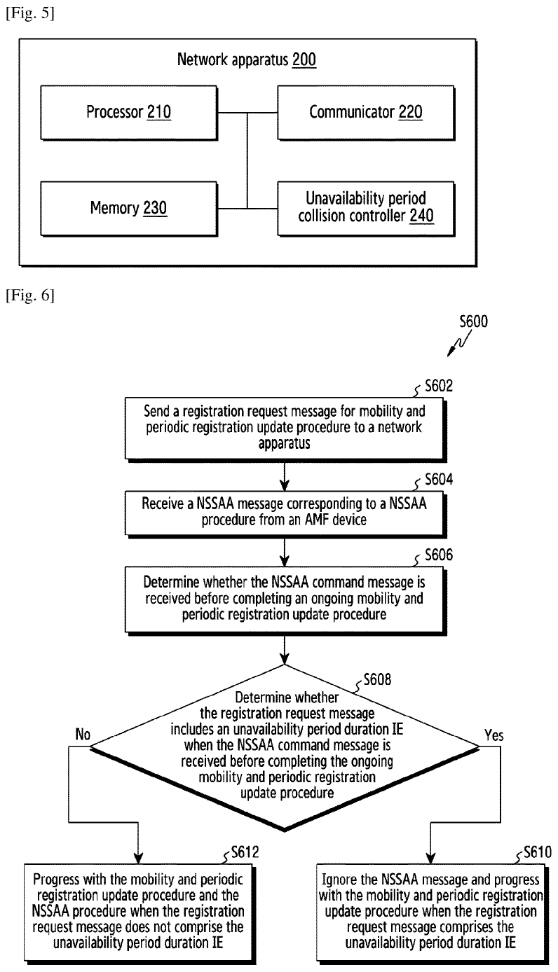

FIG. 6 is a flow chart (S600) illustrating a method, implemented by the UE (100), for handling the unavailability period collision in the wireless network (1000), according to the embodiments as disclosed herein. The operations (S602-S612) are handled by the unavailability period collision controller (140).

At step S602, the method includes sending the registration request message for mobility and periodic registration update procedure to the network apparatus (200). At step S604, the method includes receiving the NSSAA message corresponding to the NSSAA procedure from the AMF device (300). At step S606, the method includes determining that the NSSAA command message is received before completing the ongoing mobility and periodic registration update procedure. At step S608, the method includes determining whether the registration request message includes the unavailability period duration IE, when the NSSAA command message is received before completing the ongoing mobility and periodic registration update procedure. In an embodiment, at step S610, the method includes ignoring the NSSAA message and progressing with the mobility and periodic registration update procedure, when the registration request message includes the unavailability period duration IE. In another embodiment, at step S612, the method includes progressing with the mobility and periodic registration update procedure and the NSSAA procedure when the registration request message does not include the unavailability period duration IE.

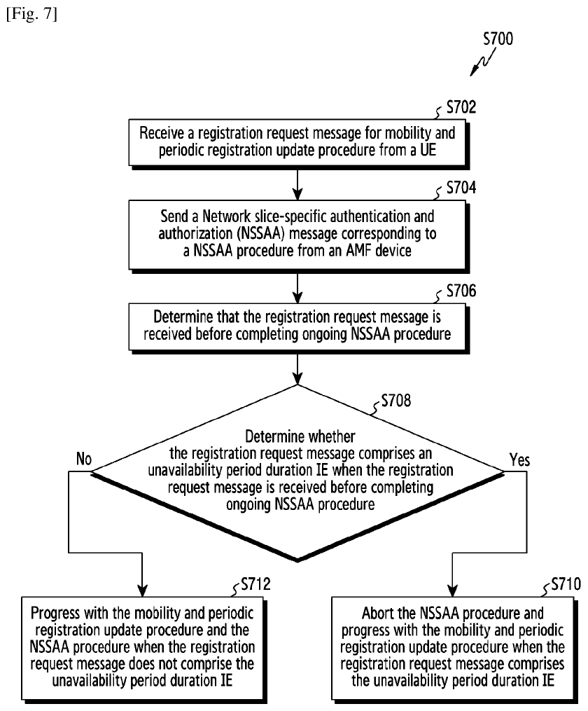

FIG. 7 is a flow chart (S700) illustrating a method, implemented by the network apparatus (200), for handling the unavailability period collision in the wireless network (1000), according to the embodiments as disclosed herein. The operations (S702-S712) are handled by the unavailability period collision controller (240).

At step S702, the method includes receiving the registration request message for mobility and periodic registration update procedure from the UE (100). At step S704, the method includes sending the NSSAA message corresponding to the NSSAA procedure from the AMF device (300). At step S706, the method includes determining that the registration request message is received before completing the going NSSAA procedure. At step S708, the method includes determining whether the registration request message includes an unavailability period duration IE when the registration request message is received before completing the ongoing NSSAA procedure. In an embodiment, at step S710, the method includes aborting the NSSAA procedure and progressing with the mobility and periodic registration update procedure when the registration request message includes the unavailability period duration IE. In another embodiment, at step S712, the method includes progressing with the mobility and periodic registration update procedure and the NSSAA procedure when the registration request message does not include the unavailability period duration IE.

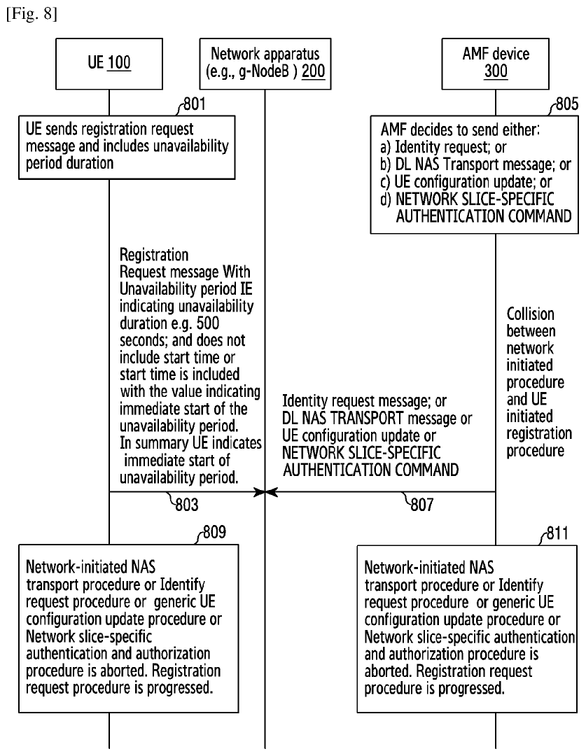

FIG. 8 is another sequential diagram illustrating signalling among the UE (100), the network apparatus (e.g., g-NodeB) (200) and the AMF device (300) for unavailability period collision case handling in the wireless network (1000), according to an embodiment as disclosed herein.

At step 801, the UE (100) sends the registration request message including the unavailability period duration. At step 803, the UE (100) sends the registration request message with unavailability period IE indicating unavailability duration e.g., 500 seconds. The unavailability period IE/NAS message e.g., REGISTRATION/DEREGISTRATION REQUEST message does not include the start time or the start time is included with the value indicating immediate start of the unavailability period. In summary, the UE (100) indicates the immediate start of unavailability period to the network.

At step 805 and at step 807, the AMF device (300) decides to send either the identity request, or the DL NAS transport message, or the UE configuration update, or the network slice-specific authentication command without knowing that UE also has initiated a procedure in step 801.

At step 809, in the UE side, the network-initiated NAS transport procedure or the identify request procedure or the generic UE configuration update procedure or the network slice-specific authentication and authorization procedure is aborted. The registration request procedure is progressed. At step 811, in the AMF device side, the network-initiated NAS transport procedure or the identify request procedure or the generic UE configuration update procedure or the network slice-specific authentication and authorization procedure is aborted. The registration request procedure is progressed.

In an example, at the UE side, if the registration request message (or any other NAS message e.g. deregistration message) sent by the UE (100) does not include unavailability period duration IE i.e. start time of unavailability is not immediately i.e. even the start time is not included by the UE (100) and the UE (100) receives the identify request message or the DL NAS transport message or the configuration update command message or the network slice-specific authentication command message before the ongoing registration request procedure has been completed, the UE (100) shall proceed with both the procedures.

If the registration request message (or any other NAS message e.g. deregistration message or the like) includes the unavailability period duration IE and does not include the start time implying that the unavailability period will start immediately or start time is included but with the value indicating immediate start of the unavailability period and the UE (100) receives the identify request message or the DL NAS transport message or the configuration update command message or the network slice-specific authentication command message before the ongoing registration request procedure has been completed, the UE (100) shall ignore/discard the identify request message or the DL NAS transport message or the configuration update command message or the network slice-specific authentication command message received from network and proceed with the registration request procedure.

For example, the UE (100) includes the unavailability duration as 500 seconds and does not include start time information in the NAS message like registration request message or deregistration request message. In another example, if the UE (100) includes the unavailability duration as 500 seconds and includes start time duration as 0 seconds (implying there is no delay in start of unavailability i.e., unavailability period is started immediately) in the NAS message like registration request message or deregistration request message. In another example, if the UE (100) includes unavailability duration as 500 seconds and includes start time with the time stamp or time slot or any other such time unit implying to the network apparatus (200) that unavailability period has to be started immediately in the NAS message like registration request message or deregistration request message. Then, the UE (100) will proceed with registration procedure and ignore/discard the received identify request message or the DL NAS transport message or the configuration update command message or the network slice-specific authentication command message received from the AMF device (300) during the collision case of this two procedures.

In summary, if the UE (100) has sent the information in the NAS message like registration request message or deregistration request message indicating that the unavailability period has to be started immediately and if the UE (100) receives the identify request message or the DL NAS transport message or the configuration update command message or the network slice-specific authentication command message before the ongoing registration request procedure has been completed, the UE (100) shall ignore/discard the identify request message or the DL NAS transport message or the configuration update command message or the network slice-specific authentication command message received from network and proceed with the registration procedure.

At the network side, if the AMF device (300) receives the registration request message before the ongoing generic UE configuration update procedure/network-initiated NAS transport procedure/Identify request procedure has been completed and the registration request message (or any other NAS message) does not include the unavailability period duration IE or information implying immediate start of unavailability both the procedures shall be progressed. If the AMF device (300) receives the registration request message before the ongoing generic UE configuration update procedure/network-initiated NAS transport procedure/Identify request procedure/Network slice-specific authentication and authorization procedure has been completed and the registration request message (or any other NAS message) include unavailability period duration IE or includes unavailability period duration IE but does not include a start time implying that the unavailability period will start immediately or start time is included but with the value indicating immediate start of the unavailability period, the AMF device (300) shall abort the generic UE configuration update/network-initiated NAS transport procedure/Identify request procedure/Network slice-specific authentication and authorization procedure and shall progress the registration procedure.

For example before the ongoing generic UE configuration update procedure/network-initiated NAS transport procedure/Identify request procedure/Network slice-specific authentication and authorization procedure has been completed, the AMF device (300) receives the NAS message like registration request message or deregistration request message, if the UE (100) includes unavailability duration as 500 seconds and does not include start time information in NAS message like registration request message or deregistration request message, or if the UE (100) includes unavailability duration as 500 seconds and includes start time duration as 0 seconds (implying there is no delay in start of unavailability i.e. unavailability period is started immediately) in NAS message like registration request message or deregistration request message; or if the UE includes unavailability duration as 500 seconds and includes start time with a time stamp or time slot or any other such time unit implying to the network that unavailability period has to be started immediately in NAS message like registration request message or deregistration request message. Then, the AMF device (300) shall abort the generic UE configuration update/network-initiated NAS transport procedure/Identify request procedure/Network slice-specific authentication and authorization procedure and shall progress the UE initiated NAS procedure like registration procedure or deregistration procedure.

In summary before the ongoing generic UE configuration update procedure/network-initiated NAS transport procedure/Identify request procedure/Network slice-specific authentication and authorization procedure has been completed, the AMF device (300) receives the NAS message like registration request message or deregistration request message indicating that unavailability period has to be started immediately then network shall abort the generic UE configuration update/network-initiated NAS transport procedure/Identify request procedure/Network slice-specific authentication and authorization procedure and shall progress the UE initiated NAS procedure like registration procedure or deregistration procedure.

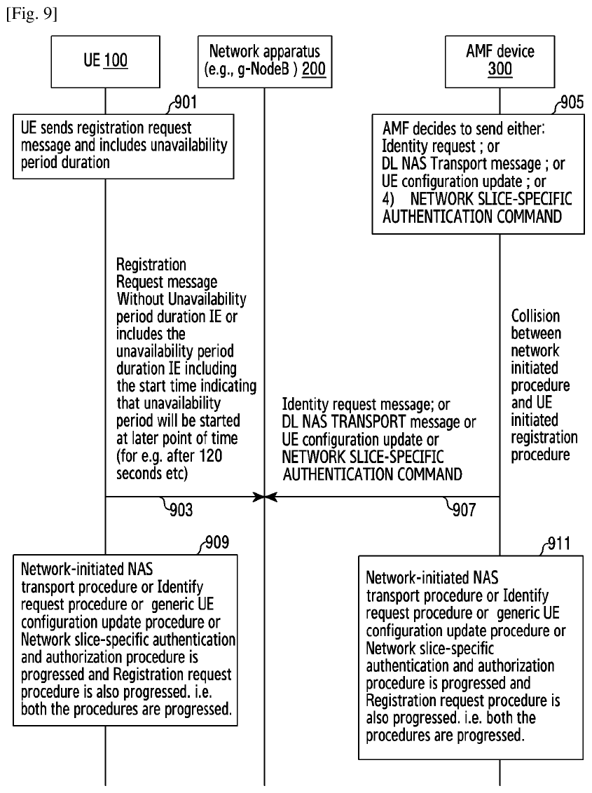

FIG. 9 is another sequential diagram illustrating signalling among the UE (100), the network apparatus (e.g., g-NodeB) (200) and the AMF device (300) for unavailability period collision case handling in the wireless network (1000), according to an embodiment as disclosed herein.

At step 901 and 903, the UE (100) sends the registration request message with the unavailability period IE indicating unavailability duration e.g., 500 seconds and does not include start time or start time is included with the value indicating immediate start of the unavailability period. In summary, the UE (100) indicates immediate start of unavailability period. At step 905 and 907, the AMF device (300) decides to send either identity request, or DL NAS transport message, or UE configuration update, or the network slice-specific authentication command.

If the collision between the network initiated procedure and the UE initiated registration procedure then, at step 909 and step 909, the network-initiated NAS transport procedure or the identify request procedure or the generic UE configuration update procedure or the network slice-specific authentication and authorization procedure is aborted. The registration request procedure is progressed.

In other words, at the UE side, if the registration request message (or any other NAS message e.g. deregistration message) sent by the UE (100) does not include the unavailability period duration IE or includes unavailability period duration but also include start time implying that unavailability is not immediately i.e. even the start time is not included by the UE (100) and the UE (100) receives the identify request message or the DL NAS transport message or the configuration update command message or the network slice-specific authentication command message before the ongoing registration request procedure has been completed, the UE (100) shall proceed with both the procedures.

For example, the UE (100) includes unavailability duration as 500 seconds and also include start time as 100 seconds information in NAS message like registration request message or deregistration request message implying that unavailability period will start after 100 seconds of time. In another example, if the UE (100) includes unavailability duration as 500 seconds and includes start time with a time stamp or time slot or any other such time unit implying to the network that unavailability period will be started at later point of time in NAS message e.g., registration request message or deregistration request message. Then, the UE (100) will proceed with the registration procedure and also with the received identify request message or the DL NAS transport message or the configuration update command message or the network slice-specific authentication command message received from the AMF device (300) during the collision case of these two procedures (i.e., both the procedures will be progressed).

In summary, if the UE (100) has sent the information in the NAS message like registration request message or deregistration request message indicating that unavailability period is not started or will be started at later point of time and if the UE (100) receives the identify request message or the DL NAS transport message or the configuration update command message or the network slice-specific authentication command message before the ongoing registration request procedure has been completed, the UE (100) shall progress the identify request message or the DL NAS transport message or the configuration update command message or the network slice-specific authentication command message received from the AMF device (300) and also proceed with the registration procedure i.e. both the procedures are progressed.

In other words, at the network side, if the AMF device (300) receives the registration request message before the ongoing generic UE configuration update procedure/network-initiated NAS transport procedure/identify request procedure has been completed and the registration request message (or any other NAS message) does not include the unavailability period duration IE or information implying immediate start of unavailability both the procedures shall be progressed. For example, before the ongoing generic UE configuration update procedure/network-initiated NAS transport procedure/Identify request procedure/Network slice-specific authentication and authorization procedure has been completed, the AMF device (300) receives the NAS message like registration request message or the deregistration request message.

Consider, if the UE (100) includes unavailability duration as 500 seconds and also include start time as 100 seconds information in the NAS message like registration request message or deregistration request message that implies unavailability period will start after 100 seconds of time, or if the UE (100) includes unavailability duration as 500 seconds and includes start time with a time stamp or time slot or any other such time unit implying to the network that unavailability period will be started at later point of time in NAS message e.g. registration request message or deregistration request message then the AMF device (300) shall progress the generic UE configuration update/network-initiated NAS transport procedure/identify request procedure/the network slice-specific authentication and authorization procedure and shall also progress the UE initiated NAS procedure like registration procedure or deregistration procedure. i.e., both the procedures are progressed.

In summary before the ongoing generic UE configuration update procedure/network-initiated NAS transport procedure/Identify request procedure/Network slice-specific authentication and authorization procedure has been completed, the AMF device (300) receives the NAS message like registration request message or deregistration request message indicating that unavailability period will be started at later point of time then AMF device (300) shall progress the generic UE configuration update/network-initiated NAS transport procedure/Identify request procedure/Network slice-specific authentication and authorization procedure and shall also progress the UE initiated NAS procedure like registration procedure or deregistration procedure. i.e., both the procedures are progressed.

The various actions, acts, blocks, steps, or the like in the flow charts (S600 and S700) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by an access and mobility management function (AMF) entity in a wireless communication system, the method comprising:
identifying that a collision occurs between a network slice specific authentication and authorization (NSSAA) procedure and a registration procedure; and
in case that a registration request message for the registration procedure includes information on an unavailable period, aborting the NSSAA procedure.

2. The method of claim 1,
wherein the registration request message is received before the NSSAA procedure is completed.

3. The method of claim 1, further comprising
performing the registration procedure based on the registration request message.

4. The method of claim 2,
in case that the registration request message for the registration procedure is not include the information on the unavailable period, performing both of the NSSAA procedure and the registration procedure.

5. An access and mobility management function (AMF) entity in a wireless communication system, the AMF entity comprising:
a transceiver, and
a controller coupled with the transceiver and configured to:
identify that a collision occurs between a network slice specific authentication and authorization (NSSAA) procedure and a registration procedure, and
in case that a registration request message for the registration procedure includes information on an unavailable period, abort the NSSAA procedure.

6. The AMF entity of claim 5,
wherein the registration request message is received before the NSSAA procedure is completed.

7. The AMF entity of claim 5, wherein the controller further configured to perform the registration procedure based on the registration request message.

8. The AMF entity of claim 6, wherein the controller configured to in case that the registration request message for the registration procedure is not include the information on the unavailable period, perform both of the NSSAA procedure and the registration procedure.

9. A method performed by a user equipment (UE) in a wireless communication system, the method comprising:
identifying that a collision occurs between a network slice specific authentication and authorization (NSSAA) procedure and a registration procedure; and
in case that a registration request message for the registration procedure includes information on an unavailable period, ignoring a network slice specific authentication command message for the NSSAA procedure.

10. The method of claim 9,
wherein the network slice specific authentication command message is received before the NSSAA procedure is completed.

11. The method of claim 9, further comprising
performing the registration procedure based on the registration request message.

12. The method of claim 10,
in case that the registration request message for the registration procedure does not include the information on the unavailable period, performing both of the NSSAA procedure and the registration procedure.

13. A user equipment (UE) in a wireless communication system, the UE comprising:
a transceiver, and
a controller coupled with the transceiver and configured to:
identify that a collision occurs between a network slice specific authentication and authorization (NSSAA) procedure and a registration procedure, and
in case that a registration request message for the registration procedure includes information on an unavailable period, ignore a network slice specific authentication command message for the NSSAA procedure.

14. The UE of claim 13,
wherein the network slice specific authentication command message is received before the NSSAA procedure is completed,
in case that the registration request message for the registration procedure does not include the information on the unavailable period, performing both of the NSSAA procedure and the registration procedure.

15. The UE of claim 13, wherein the controller further configured to perform the registration procedure based on the registration request message.
